(19) United States
(12) Patent Application Publication
(10) Pub. No.: US 2026/0111173 A1
(43) Pub. Date: Apr. 23, 2026

(54) ON-CHIP NON-ZERO VALUE UNPACKING AND DISTRIBUTION

(71) Applicant: EDGECORTIX INC., Tokyo (JP)

(72) Inventors: Oleg KHAVIN, Tokyo (JP); Anudeep CHERLAPALLY, Tokyo (JP); Kunihiko IETOMI, Tokyo (JP); Nikolay NEZ, Tokyo (JP); Sakyasingha DASGUPTA, Tokyo (JP)

(21) Appl. No.: 18/919,357

(22) Filed: Oct. 17, 2024

(51) Int. Cl. G06F 7/487; G06F 7/485; G06F 12/06

(52) U.S. Cl. CPC G06F 7/487; G06F 7/485; G06F 12/0646

(57) ABSTRACT

On-chip non-zero value unpacking and distribution is implemented by a plurality of multiply-and-accumulate (MAC) units, a memory in communication with the plurality of MAC units, and an unpacker configured to receive packed non-zero values from the memory, and, for each non-zero value among the packed non-zero values, correlate the non-zero value with a corresponding MAC unit among the plurality of MAC units, combine the non-zero value with an address of the corresponding MAC unit, and transmit the non-zero value and the address to a corresponding load path connected to the corresponding MAC unit among a plurality of load paths.

### BACKGROUND

Neural network inference chips utilize a plurality of multiply-and-accumulate (MAC) units arranged in a systolic array. Weight registers of the MAC units are connected to a memory and other internal components of the chip through one of a plurality of run paths, where one run path is connected to multiple MAC units in series. A page including ordered weight values is transmitted through the run path such that each subsequent weight register receives a subsequent weight value, sometimes referred to as a shift-based manner.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for on-chip non-zero value unpacking and distribution, according to at least some embodiments of the subject disclosure.

FIG. 2 is a schematic diagram of an integrated circuit, according to at least some embodiments of the subject disclosure.

FIG. 3 is a schematic diagram of a systolic array 310, according to at least some embodiments of the subject disclosure.

FIG. 4 is a schematic diagram of a MAC unit 420, according to at least some embodiments of the subject disclosure.

FIG. 5 is an operational flow for on-chip non-zero value unpacking and distribution, according to at least some embodiments of the subject disclosure.

FIG. 6 is an operational flow for loading weight values, according to at least some embodiments of the subject disclosure.

FIG. 7 is an operational flow for unpacking values, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

A page includes a weight value for each MAC unit connected to the run path, even where that weight value is zero. However, before the MAC units of the systolic array are populated with weight values, the weight registers are reset, or “cleared” such that each weight register stores data equivalent to a value of zero. In other words, each weight register is already storing a value of zero. In many instances of neural network inference, the weight values are mostly zero, in a condition sometimes referred to as “sparse weights”. Usage of resources to transmit zero values to the weight registers are sometimes viewed as unnecessary. A page including only a small portion of zero values is seldomly concerning. However, in transmitting a sparse weights page having only a small portion of non-zero values, most of the resources are used for values that are already stored in the weight registers.

In at least some embodiments described herein, an integrated circuit for neural network inference features a systolic array including load paths in addition to the usual run paths, and a hardware unpacker at an interface between the systolic array and the other components of the integrated circuit. In at least some embodiments, the unpacker is configured to unpack packed non-zero values received from a memory, and distribute the unpacked non-zero values to respective MAC units through the load paths. In at least some embodiments, each load path connects to an address decoder and a load register of the MAC units connected to the load path, and the load register connects to a weight register of the MAC unit. In at least some embodiments, the unpacker transmits each non-zero weight value in combination with an address identifying a MAC unit. In at least some embodiments, the address decoder of the identified MAC unit stores, in the load register, the non-zero weight value received through the load path in response to verifying the address. In at least some embodiments, an “update” command is transmitted through the run path, which causes the weight value stored in the load register to be stored in the weight register. In at least some embodiments, the unpacker is configured to apply one of multiple methods of unpacking to match the packing method of the packed weights. In at least some embodiments, packing methods include element-wise packing, mask-based coding, address-based coding, Look-Up Table indexing, or any other method of data compression. In at least some embodiments, the packed weights are initially packed according to a packing method determined by a compiler based on lowest memory size.

In at least some embodiments, the packed weights does not need to include weight values equal to zero, and therefore the data size of the packed weights is reduced, especially for sparse weights. In at least some embodiments, the reduced data size of the packed weights reduces bandwidth and memory size requirements.

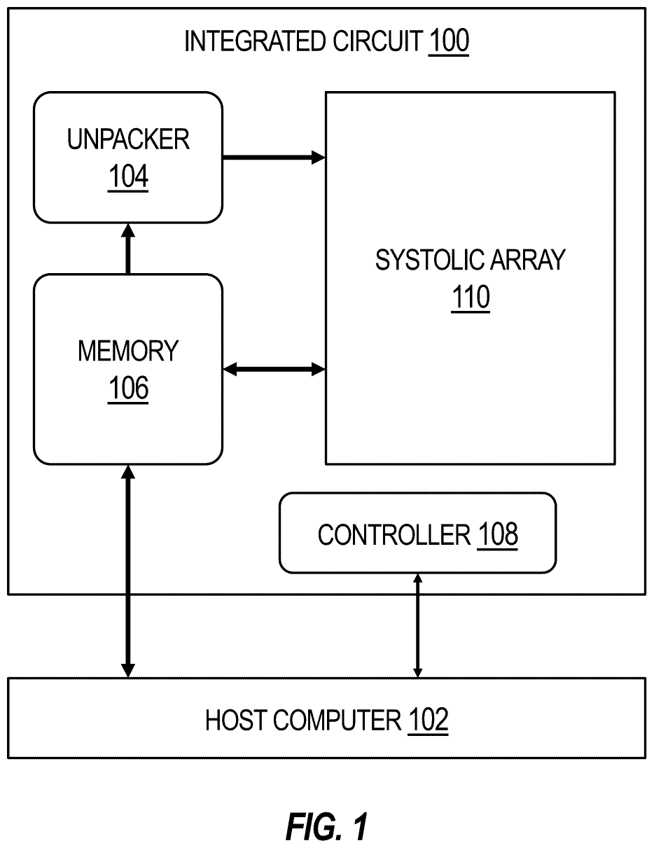

FIG. 1 is a schematic diagram of a system for on-chip non-zero value unpacking and distribution, according to at least some embodiments of the subject disclosure. The system for on-chip non-zero value unpacking and distribution includes integrated circuit 100 and host computer 102.

Integrated circuit 100 is a component of the system for hardware configuration for non-zero value distribution. In at least some embodiments, integrated circuit 100 is configured to house unpacker 104, memory 106, controller 108, and systolic array 110 for neural network inference. In at least some embodiments, integrated circuit 100 is configured to facilitate distribution of non-zero values through load paths. In at least some embodiments, integrated circuit 100 is configured to interface with host computer 102. In at least some embodiments, integrated circuit 100 is configured to receive packed non-zero values from host computer 102, and store the packed non-zero values on memory 106. In at least some embodiments, integrated circuit 100 is one of an ASIC (Application-Specific Integrated Circuit), an FPGA (Field-Programmable Gate Arrays), an SoC (System on Chips), etc.

Host computer 102 is a component of the system for on-chip non-zero value unpacking and distribution. In at least some embodiments, host computer 102 is configured to determine a packing method for non-zero values. In at least some embodiments, host computer 102 is configured to pack non-zero values. In at least some embodiments, host computer 102 is configured to transmit packed non-zero values to integrated circuit 100. In at least some embodiments, host computer 102 is configured to interface with controller 108 to manage data flow. In at least some embodiments, host computer 102 is configured to perform general-purpose computing tasks, run software applications, manage peripherals, etc. In at least some embodiments, host computer 102 is one or more desktop computers, servers, workstations, instances of cloud computing, etc. In at least some embodiments, host computer 102 is in communication with the integrated circuit. In at least some embodiments, the host computer is configured to determine a packing method of the packed non-zero values, pack the non-zero values to produce the packed non-zero values according to the packing method, and transmit the packed non-zero values to the memory.

Unpacker 104 is a component of integrated circuit 100. In at least some embodiments, unpacker 104 is configured to receive packed non-zero values from memory 106. In at least some embodiments, unpacker 104 is configured to unpack non-zero values. In at least some embodiments, unpacker 104 is configured to distribute non-zero values to MAC units through load paths. In at least some embodiments, unpacker 104 is configured to perform unpacking of data packed with any of multiple packing methods. In at least some embodiments, unpacker 104 is made up of gates and registers within integrated circuit 100.

Memory 106 is a component of integrated circuit 100. In at least some embodiments, memory 106 is configured to store packed non-zero values and activation values. In at least some embodiments, memory 106 stores a non-zero value package. In at least some embodiments, memory 106 is configured to provide data to unpacker 104 and systolic array 110. In at least some embodiments, memory 106 is configured to receive instructions from controller 108 to manage data flow. In at least some embodiments, memory 106 is configured to serve general data storage purposes for various components of integrated circuit 100. In at least some embodiments, memory 106 is in the form of flash memory or other types of on-chip memory.

Controller 108 is a component of integrated circuit 100. In at least some embodiments, controller 108 is configured to manage flow of non-zero values and activation values. In at least some embodiments, controller 108 is configured to interface with memory 106, unpacker 104, and systolic array 110. In at least some embodiments, controller 108 is configured to communicate with host computer 102. In at least some embodiments, controller 108 is in the form of one or more microcontrollers, control units, etc. In at least some embodiments, controller 108 is configured to transmit, from memory 106, the packed non-zero values to unpacker 104, transmit, from memory 106, a plurality of activation values to a plurality of MAC units, and store, on memory 106, a plurality of output sum values from the plurality of MAC units. In at least some embodiments, controller 108 is configured to transmit, from memory 106, the non-zero value package to the unpacker 104, transmit, from memory 106, a plurality of activation values to a plurality of MAC units, and store, on memory 106, a plurality of output sum values from the plurality of MAC units.

Systolic array 110 is a component of integrated circuit 100. In at least some embodiments, systolic array 110 is configured to perform parallel processing of values for neural network inference. In at least some embodiments, systolic array 110 is configured to interface with unpacker 104, memory 106, and controller 108. In at least some embodiments, systolic array 110 includes a plurality of MAC units for data processing. In at least some embodiments, systolic array 110 is configured to interface with various data processing and storage units.

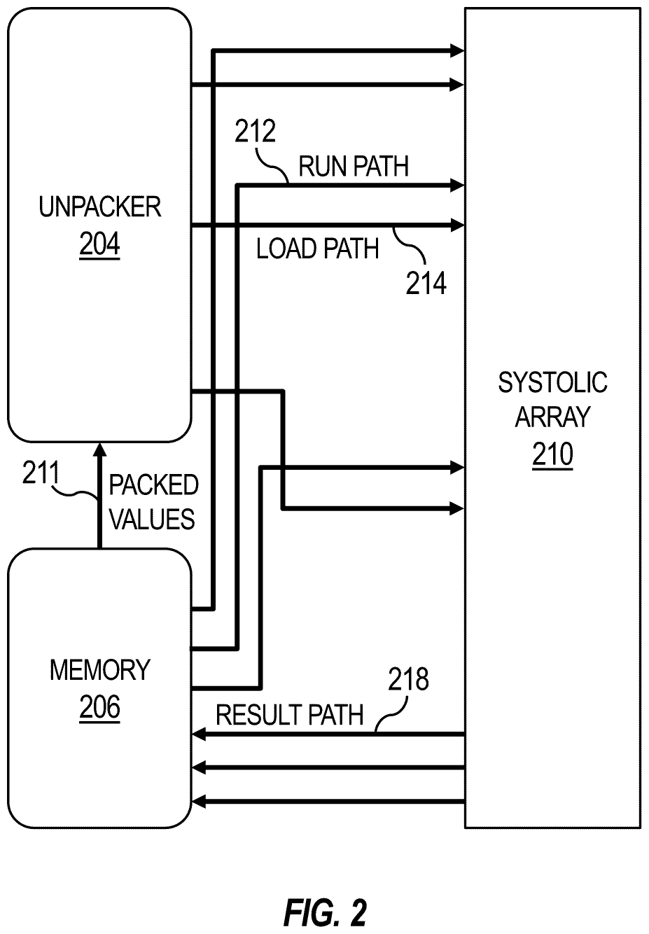

FIG. 2 is a schematic diagram of an integrated circuit, according to at least some embodiments of the subject disclosure. The integrated circuit includes unpacker 204, memory 206, systolic array 210, run path 212, load path 214, and result path 218. The descriptions of unpacker 104 of FIG. 1 are applicable to unpacker 204. The descriptions of memory 106 of FIG. 1 are applicable to memory 106. The descriptions of systolic array 110 of FIG. 1 are applicable to systolic array 210.

Unpacker 204 is a component of the integrated circuit. In at least some embodiments, unpacker 204 in an integrated circuit is configured to unpack packed non-zero values received from memory 206, such as packed non-zero values 211. In at least some embodiments, unpacker 204 is connected to the plurality of MAC units by a plurality of load paths, such as load path 214. In at least some embodiments, unpacker 204 is configured to distribute these unpacked values to systolic array 210 through load paths, such as load path 214. In at least some embodiments, unpacker 204 is configured to receive packed non-zero values from memory 206, and, for each non-zero value among the packed non-zero values, correlate the non-zero value with a corresponding MAC unit among the plurality of MAC units, combine the non-zero value with an address of the corresponding MAC unit, and transmit the non-zero value and the address to a corresponding load path connected to the corresponding MAC unit among a plurality of load paths. In at least some embodiments, the unpacker is further configured to determine the corresponding load path based on the row identifier, and the address is the column identifier. In at least some embodiments, unpacker 204 is configured to read a non-zero value package from memory 206, and, for each non-zero value among a plurality of non-zero values in the non-zero value package, associate the non-zero value with an associated MAC unit among the plurality of MAC units, couple the non-zero value with the address value of the associated MAC unit, and transmit the non-zero value and the address value through the corresponding load path, such as load path 214, connected to the associated MAC unit.

Memory 206 is a component of the integrated circuit. In at least some embodiments, memory 206 is configured to store packed non-zero values and activation values. In at least some embodiments, memory 206 is configured to supply packed non-zero values to unpacker 204. In at least some embodiments, memory 206 is configured to provide activation values to systolic array 210. In at least some embodiments, memory 206 is configured to store output sum values received from systolic array 210.

Systolic array 210 is a component of the integrated circuit. In at least some embodiments, systolic array 210 is configured to perform parallel processing of data using multiple MAC units. In at least some embodiments, systolic array 210 interacts with other components by receiving unpacked non-zero values and activation values from unpacker 204 and memory 206. In at least some embodiments, systolic array 210 is configured to transmit output sum values to result paths.

Run path 212 is a component of the integrated circuit. In at least some embodiments, run path 212 is configured for transmission of activation values from memory 206 to systolic array 210. In at least some embodiments, run path 212 is configured to facilitate the flow of data during the computation phase.

Load path 214 is a component of the integrated circuit. In at least some embodiments, load path 214 is configured for transmission of unpacked non-zero values and addresses to systolic array 210. In at least some embodiments, load path 214 connects unpacker 204 to systolic array 210 for data distribution.

Result path 218 is a component of the integrated circuit. In at least some embodiments, result path 218 is configured for transmission of processed data from systolic array 210 to memory 206. In at least some embodiments, result path 218 is configured for transmission of output sum values from systolic array 210 to memory 206.

Packed values 211 is a form of data processed by the integrated circuit. In at least some embodiments, packed values 211 represent compressed data to be unpacked and processed. In at least some embodiments, packed values 211 optimize memory usage by storing only non-zero values. In at least some embodiments, packed values 211 are stored in memory 206 and unpacked by unpacker 204.

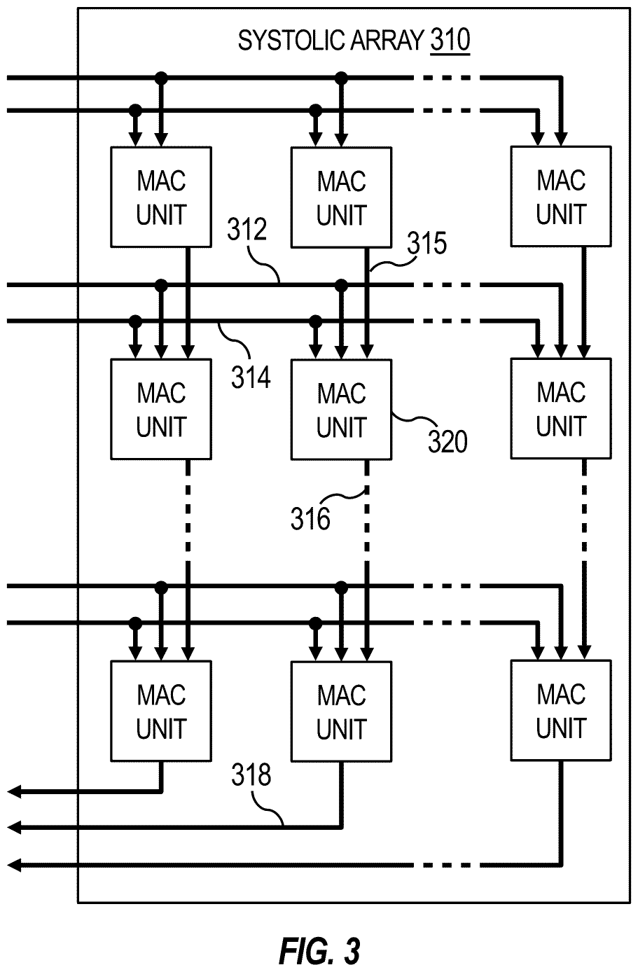

FIG. 3 is a schematic diagram of a systolic array 310, according to at least some embodiments of the subject disclosure. The systolic array 310 includes a plurality of MAC units, such as MAC unit 320, a plurality of run paths, such as run path 312, a plurality of load paths, such as load path 314, a plurality of input sum paths, such as input sum path 315, a plurality of output sum paths, such as output sum path 316, and a plurality of result paths, such as result path 318. The descriptions of run path 212 of FIG. 2 are applicable to run path 312. The descriptions of load path 214 of FIG. 2 are applicable to load path 314. The descriptions of result path 218 of FIG. 2 are applicable to result path 318.

MAC unit 320 is a component of systolic array 310. In at least some embodiments, MAC unit 320 is configured to perform multiply-and-accumulate operations. In at least some embodiments, MAC unit 320 is configured to receive non-zero weight values from an unpacker via load path 314. In at least some embodiments, MAC unit 320 is configured to receive activation values from a memory via run path 312. In at least some embodiments, MAC unit 320 is configured to output sum values to a downstream MAC unit via output sum path 316. In at least some embodiments, MAC unit 320 is configured to handle general arithmetic operations such as multiplication and addition. In at least some embodiments, each MAC unit among the plurality of MAC units includes a register configured to store the non-zero value received from the corresponding load path, and an address decoder configured to instruct the register to store the non-zero value in response to validating the address received from the corresponding load path. In at least some embodiments, each MAC unit among the plurality of MAC units includes a register configured to store a non-zero value received from a corresponding load path among a plurality of load paths, and an address decoder configured to store the non-zero value in the register in response to validating an address value coupled to the non-zero value. In at least some embodiments, the register includes a load register and an active register, and the controller is further configured to instruct each MAC unit among the plurality of MAC units to transfer the non-zero value from the load register to the active register. In at least some embodiments, each MAC unit is identified by a row identifier and a column identifier.

Input sum path 315 is a component of systolic array 310. In at least some embodiments, input sum path 315 is configured for transmission of input sum values to MAC unit 320 from an upstream MAC unit for accumulation.

Output sum path 316 is a component of systolic array 310. In at least some embodiments, output sum path 316 is configured for transmission of output sum values from MAC unit 320 to a downstream MAC unit.

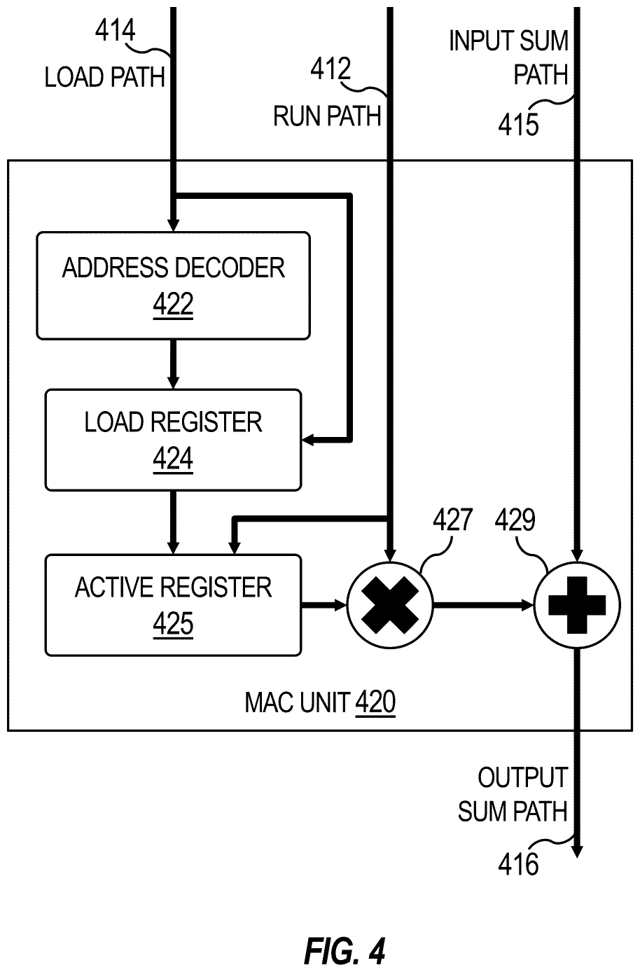

FIG. 4 is a schematic diagram of a MAC unit 420, according to at least some embodiments of the subject disclosure. MAC unit 420 includes address decoder 422, load register 424, active register 425, multiplier 427, and adder 429. The descriptions of run path 212 of FIG. 2 and run path 312 of FIG. 3 are applicable to run path 412. The descriptions of load path 214 of FIG. 2 and load path 314 of FIG. 3 are applicable to load path 414. The descriptions of input sum path 315 of FIG. 3 are applicable to input sum path 415. The descriptions of output sum path 316 of FIG. 3 are applicable to output sum path 416.

Address decoder 422 is a component of MAC unit 420. In at least some embodiments, address decoder 422 is configured to decode addresses received via load path 414 to determine whether MAC unit 420 is where a non-zero value combined with the address should be stored. In at least some embodiments, address decoder 422 instructs load register 424 to store the non-zero value in response to validating the address.

Load register 424 is a component of MAC unit 420. In at least some embodiments, load register 424 is configured to temporarily store a non-zero value received via load path 414 until the non-zero value is transferred to active register 425. In at least some embodiments, load register 424 transfers stored values to active register 425 upon receiving an update command. In at least some embodiments, load register 424 is configured for general data storage and transfer. In at least some embodiments, load register 424 is of the type typically used for temporary data storage in CPUs, GPUs, and other digital circuits. In at least some embodiments, the controller is further configured to instruct each MAC unit among the plurality of MAC units to clear the register.

Active register 425 is a component of MAC unit 420. In at least some embodiments, active register 425 is configured to store a non-zero value that is actively used in multiplication operations within MAC unit 420. In at least some embodiments, active register 425 receives values from load register 414. In at least some embodiments, active register 425 provides values to multiplier 427 for computation. In at least some embodiments, active register 425 is configured for general data storage and transfer. In at least some embodiments, active register 425 is of the type typically used for temporary data storage in CPUs, GPUs, and other digital circuits.

Multiplier 427 is a component of MAC unit 420. In at least some embodiments, multiplier 427 is configured to multiply the non-zero value from active register 425 with an activation value from run path 412 to produce a product value. In at least some embodiments, multiplier 427 is configured to receive non-zero values from active register 425. In at least some embodiments, multiplier 427 is configured to receive activation values from a memory via run path 415. In at least some embodiments, multiplier 427 is configured to transmit product values to adder. In at least some embodiments, multiplier 427 is configured for general multiplication operations in digital systems. In at least some embodiments, multiplier 427 is in a form suitable for FPGA modules, ASICs, CPUs, GPUs, DSPs, etc. In at least some embodiments, each MAC unit among the plurality of MAC units further includes a multiplier configured to multiply the non-zero value from the register and an activation value from a run path to produce a product value.

Adder 429 is a component of MAC unit 420. In at least some embodiments, adder 429 is configured to add the product value from multiplier and an input sum value to produce an output sum value. In at least some embodiments, adder 429 is configured to receive product values from multiplier 427. In at least some embodiments, adder 429 is configured to receive input sum values from an upstream MAC unit via input sum path 415. In at least some embodiments, adder 429 is configured to transmit output sum values to a downstream MAC unit via output sum path 416. In at least some embodiments, adder 429 is configured for general addition operations in digital systems. In at least some embodiments, adder 429 is in a form suitable for FPGA modules, ASICs, CPUs, GPUs, DSPs, etc. In at least some embodiments, each MAC unit among the plurality of MAC units further includes an adder configured to add the product value from the multiplier and an input sum value to produce an output sum value.

MAC unit 420 in FIG. 4 includes two registers, load register 424 and active register 425. In at least some embodiments, each MAC unit among the plurality of MAC units includes a register configured to store a non-zero value received from a corresponding load path among a plurality of load paths, an address decoder configured to store the non-zero value in the register in response to validating an address value coupled to the non-zero value, and a multiplier configured to multiply the non-zero value from the register and an activation value from a run path to produce a product value.

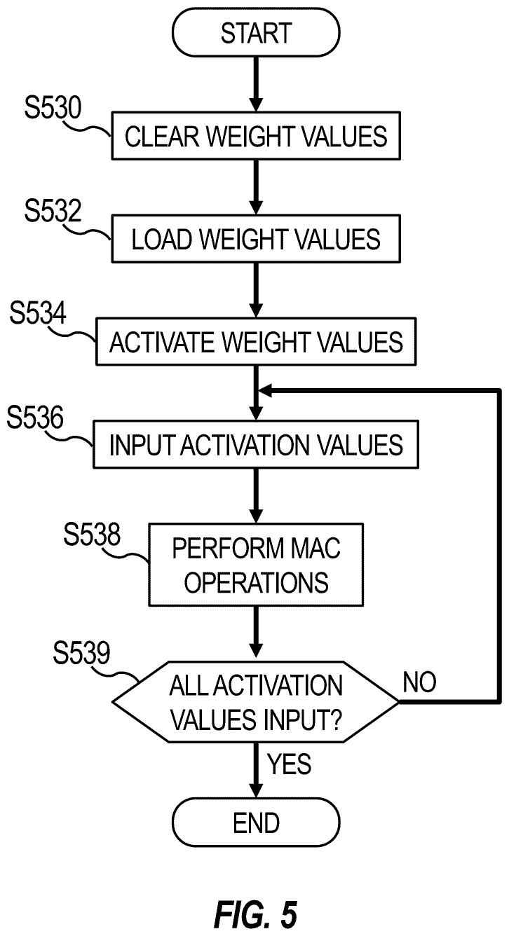

FIG. 5 is an operational flow for on-chip non-zero value unpacking and distribution, according to at least some embodiments of the subject disclosure. In at least some embodiments, the operational flow provides a method of on-chip non-zero value unpacking and distribution. In at least some embodiments, the method is performed by a controller of an integrated circuit, such controller 108 of FIG. 1.

At S530, the controller or a section thereof clears weight values. In at least some embodiments, the controller transmits a command to each MAC unit to clear the contents of their load registers, such as load register 424 of FIG. 4. In at least some embodiments, the controller causes load registers to effectively store a value of zero. In at least some embodiments, the controller causes load registers to reset to a default state, which is the equivalent to storing a value of zero. In at least some embodiments, clearing weight values ensures that no non-zero weight values are erroneously carried over and used in the next neural network inference process.

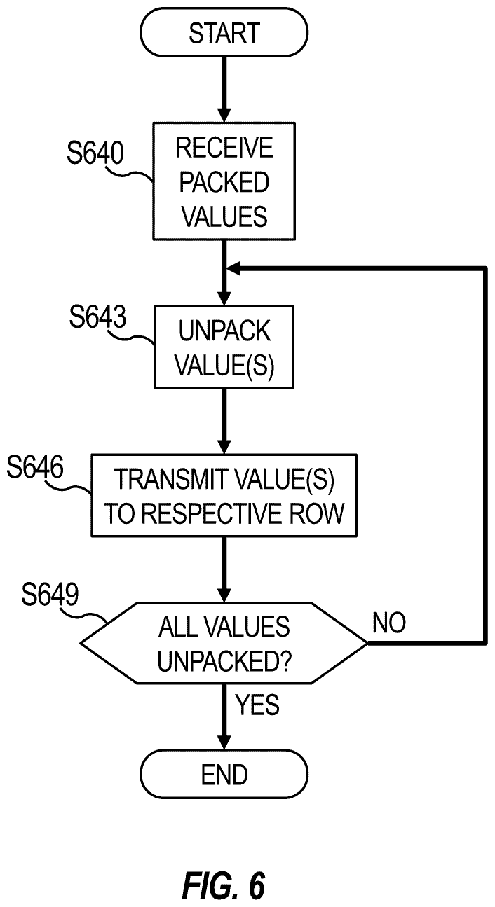

At S532, the controller or a section thereof loads weight values. In at least some embodiments, the controller causes the unpacker to receive packed non-zero weight values from the memory, unpack them, and distribute them to the appropriate MAC units via load paths. In at least some embodiments, the controller performs the operational flow of FIG. 6, described hereinafter.

At S534, the controller or a section thereof activates weight values. In at least some embodiments, the controller transmits an “update” command to the MAC units through the run path, causing weight values stored in the load registers to be transferred to respective active registers. In at least some embodiments, the controller updates the weight registers in the MAC units with the new weight values.

At S536, the controller or a section thereof inputs activation values. In at least some embodiments, the controller transmits activation values from the memory to the MAC units via the run paths. In at least some embodiments, the controller causes the activation values to be transmitted to multipliers within the MAC units.

At S538, the controller or a section thereof performs MAC operations. In at least some embodiments, the controller causes the MAC units perform multiply-and-accumulate operations using the weight values and the activation values. In at least some embodiments, the controller causes the multiplier to multiply the weight value and the activation value to produce a product value. In at least some embodiments, the controller causes the adder to add the product value to an input sum value to produce an output sum value. In at least some embodiments, the controller stores the output sum values produced by downstream MAC units in the memory.

At S539, the controller or a section thereof determines whether all activation values have been input. In response to determining that not all activation values have been input, the operational flow returns to activation value input at S536. In response to determining that all activation values have been input, the operational flow ends.

FIG. 6 is an operational flow for loading weight values, according to at least some embodiments of the subject disclosure. In at least some embodiments, the operational flow provides a method of loading weight values. In at least some embodiments, the method is performed by an unpacker of an integrated circuit, such unpacker 104 of FIG. 1.

At S640, the unpacker receives packed values. In at least some embodiments, the controller transmits packed non-zero weight values from the memory to the unpacker. In at least some embodiments, the unpacker receives the packed values through multiple paths connecting the unpacker to the memory.

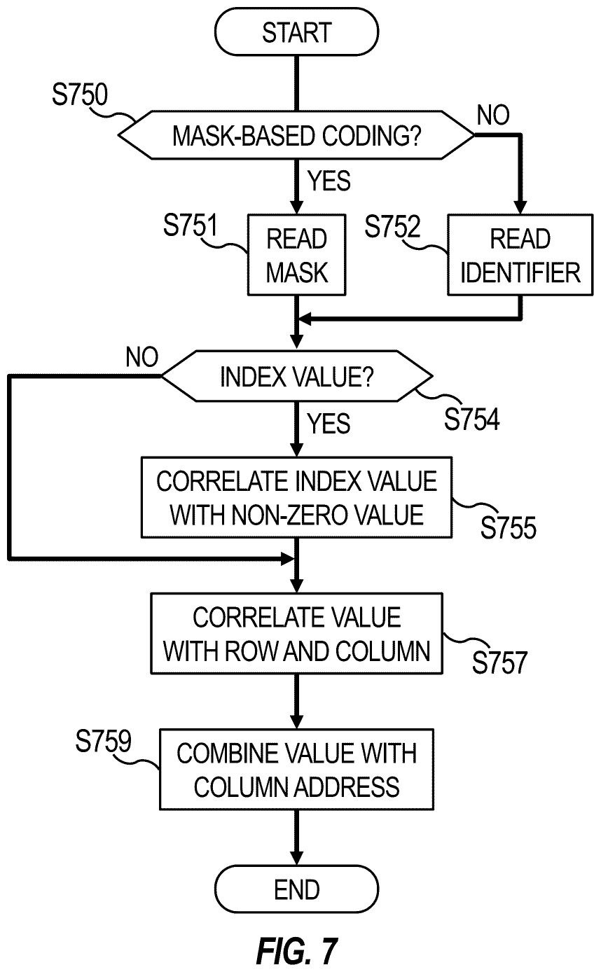

At S643, the unpacker unpacks the value(s). In at least some embodiments, the unpacker decodes or decompresses the packed non-zero values. In at least some embodiments, the unpacker unpacks according to the method of packing. In at least some embodiments, the packing method is one of addressing, masking, or indexing. In at least some embodiments, the unpacker converts the packed non-zero values into a usable format for the MAC units. In at least some embodiments, the unpacker performs the operational flow of FIG. 7, described hereinafter.

At S646, the unpacker transmits non-zero values to respective rows of MAC units. In at least some embodiments, the unpacker transmits each unpacked non-zero value along with its corresponding address to the appropriate load path. In at least some embodiments, the unpacker routes non-zero values to reach identified MAC units. In at least some embodiments, the unpacker is further configured to determine the corresponding load path based on the row identifier.

At S649, the unpacker determines whether all values have been unpacked. In response to determining that not all values have been unpacked, the operational flow returns to value unpacking at S643. In response to determining that all values have been unpacked, the operational flow ends. In at least some embodiments, the unpacker unpacks and transmits a number of values no greater than the number of load paths during a clock cycle.

FIG. 7 is an operational flow for unpacking values, according to at least some embodiments of the subject disclosure. In at least some embodiments, the operational flow provides a method of unpacking values. In at least some embodiments, the method is performed by an unpacker of an integrated circuit, such unpacker 104 of FIG. 1.

At S750, the unpacker determines whether the packing method is mask-based coding. In response to determining that the packing method is mask-based coding, the operational flow proceeds to mask reading at S751. In response to determining that the packing method is not mask-based coding, the operational flow proceeds to identifier reading at S752. In at least some embodiments, the unpacker makes the determination according to a signal from the controller. In at least some embodiments, the unpacker makes the determination according to a format of the packed values.

At S751, the unpacker reads the mask. In at least some embodiments, the unpacker reads mask values associated with packed non-zero values. In at least some embodiments, the unpacker uses the mask to determine which MAC units correspond to the non-zero values. In at least some embodiments, the unpacker identifies non-zero values and their positions within a kernel matrix. In at least some embodiments, the packed non-zero values include a mask value associated with each group of non-zero values among the packed non-zero values. In at least some embodiments, the plurality of non-zero values are separated into groups of non-zero values, each group associated with a mask value, and the unpacker is further configured to determine, for each non-zero value among the plurality of non-zero values, the corresponding load path and the address value of the associated MAC unit based on the mask value. In at least some embodiments, the packed non-zero values include one or more mask values that are not associated with non-zero values because of circumstances in which the values potentially associated with those mask values were all zero values.

At S752, the unpacker reads the identifier. In at least some embodiments, the unpacker reads identifiers associated with packed non-zero values. In at least some embodiments, the unpacker uses the identifier to determine which MAC units correspond to the non-zero values. In at least some embodiments, the packed non-zero values include an identifier of the corresponding MAC unit associated with each non-zero value among the packed non-zero values. In at least some embodiments, the non-zero value package includes, for each non-zero value among the plurality of non-zero values, an identifier of the corresponding MAC unit associated with the non-zero value, and the unpacker is further configured to determine, for each non-zero value among the plurality of non-zero values, the corresponding load path and the address value of the associated MAC unit based on the identifier.

At S754, the unpacker determines whether the non-zero value is an index value. In at least some embodiments, the unpacker determines whether the packed non-zero values are index values. In response to determining that the non-zero value is an index value, the operational flow proceeds to index value correlation at S755. In response to determining that the non-zero value is not an index value, the operational flow proceeds to row and column value correlation at S757. In at least some embodiments, the unpacker makes the determination based on a signal received from the controller. In at least some embodiments, the packed non-zero values include index values. In at least some embodiments, the unpacker is further configured to substitute each index value among the plurality of index values with a non-zero value related to the index value by an index

At S755, the unpacker correlates the index value with the non-zero value. In at least some embodiments, the unpacker correlates each index value with a corresponding non-zero value by referring to an index. In at least some embodiments, the unpacker is further configured to correlate each index value with the non-zero value by referring to an index.

At S757, the unpacker correlates the value with a row and a column of a MAC unit. In at least some embodiments, the unpacker correlates each non-zero value with corresponding row and column identifiers. In at least some embodiments, the row corresponds directly with the load path. In at least some embodiments, the correlating the non-zero value with the corresponding MAC unit includes determining the corresponding load path and the address based on the identifier. In at least some embodiments, the correlating the non-zero value with the corresponding MAC unit includes determining the corresponding load path and the address based on the mask value. In at least some embodiments, the unpacker is further configured to associate the non-zero value with an associated MAC unit among the plurality of MAC units by determining a row identifier and a column identifier encoded in the non-zero value package.

At S759, the unpacker combines the value with the column address. In at least some embodiments, the controller combines each non-zero value with its corresponding column address. In at least some embodiments, unpacker prepares the non-zero value and address for transmission to the load path. In at least some embodiments, the unpacker combines the non-zero value with the address to ensure that each non-zero value is verified by the correct MAC unit. In at least some embodiments, the unpacker is further configured to couple the non-zero value with the address value based on the column identifier, and determine the corresponding load path based on the row identifier.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

On-chip non-zero value unpacking and distribution is implemented by a plurality of multiply-and-accumulate (MAC) units, a memory in communication with the plurality of MAC units, and an unpacker configured to receive packed non-zero values from the memory, and, for each non-zero value among the packed non-zero values, correlate the non-zero value with a corresponding MAC unit among the plurality of MAC units, combine the non-zero value with an address of the corresponding MAC unit, and transmit the non-zero value and the address to a corresponding load path connected to the corresponding MAC unit among a plurality of load paths.

In at least some embodiments, each MAC unit among the plurality of MAC units further includes a multiplier configured to multiply the non-zero value from the register and an activation value from a run path to produce a product value, and an adder configured to add the product value from the multiplier and an input sum value to produce an output sum value. In at least some embodiments, on-chip non-zero value unpacking and distribution is further implemented by a controller configured to transmit, from the memory, the packed non-zero values to the unpacker, transmit, from the memory, a plurality of activation values to the plurality of MAC units, and store, on the memory, a plurality of output sum values from the plurality of MAC units. In at least some embodiments, the controller is further configured to instruct each MAC unit among the plurality of MAC units to clear the register. In at least some embodiments, the register includes a load register and an active register, the controller is further configured to instruct each MAC unit among the plurality of MAC units to transfer the non-zero value from the load register to the active register. In at least some embodiments, the packed non-zero values include an identifier of the corresponding MAC unit in associated with each non-zero value among the packed non-zero values, and the correlating the non-zero value with the corresponding MAC unit includes determining the corresponding load path and the address based on the identifier. In at least some embodiments, the packed non-zero values include a mask value associated with each group of non-zero values among the packed non-zero values, and the correlating the non-zero value with the corresponding MAC unit includes determining the corresponding load path and the address based on the mask value. In at least some embodiments, the packed non-zero values include index values, the unpacker is further configured to correlate each index value with the non-zero value by referring to an index. In at least some embodiments, each MAC unit is identified by a row identifier and a column identifier, the unpacker is further configured to determine the corresponding load path based on the row identifier, and the address is the column identifier. In at least some embodiments, on-chip non-zero value unpacking and distribution is further implemented by a host computer in communication with the integrated circuit, the host computer configured to determine a packing method of the packed non-zero values, pack the non-zero values to produce the packed non-zero values according to the packing method, and transmitting the packed non-zero values to the memory. In at least some embodiments, the packing method is one of addressing and masking. In at least some embodiments, the packing method includes indexing.

On-chip non-zero value unpacking and distribution is implemented by a plurality of multiply-and-accumulate (MAC) units, each MAC unit among the plurality of MAC units includes a register configured to store a non-zero value received from a corresponding load path among a plurality of load paths, and an address decoder configured to store the non-zero value in the register in response to validating an address value coupled to the non-zero value, a memory in communication with the plurality of MAC units, the memory storing a non-zero value package, and an unpacker connected to the plurality of MAC units by the plurality of load paths, the unpacker configured to read the non-zero value package from the memory, and, for each non-zero value among a plurality of non-zero values in the non-zero value package, associate the non-zero value with an associated MAC unit among the plurality of MAC units, couple the non-zero value with the address value of the associated MAC unit, and transmit the non-zero value and the address value through the corresponding load path connected to the associated MAC unit.

In at least some embodiments, each MAC unit among the plurality of MAC units further includes a multiplier configured to multiply the non-zero value from the register and an activation value from a run path to produce a product value, and an adder configured to add the product value from the multiplier and an input sum value to produce an output sum value. In at least some embodiments, on-chip non-zero value unpacking and distribution further includes a controller configured to transmit, from the memory, the non-zero value package to the unpacker, transmit, from the memory, a plurality of activation values to the plurality of MAC units, and store, on the memory, a plurality of output sum values from the plurality of MAC units. In at least some embodiments, the controller is further configured to instruct each MAC unit among the plurality of MAC units to clear the register. In at least some embodiments, the register includes a load register and an active register, and the controller is further configured to instruct each MAC unit among the plurality of MAC units to transfer the non-zero value from the load register to the active register. In at least some embodiments, the non-zero value package includes, for each non-zero value among the plurality of non-zero values, an identifier of the corresponding MAC unit associated with the non-zero value, and the unpacker is further configured to determine, for each non-zero value among the plurality of non-zero values, the corresponding load path and the address value of the associated MAC unit based on the identifier. In at least some embodiments, the plurality of non-zero values are separated into groups of non-zero values, each group associated with a mask value, and the unpacker is further configured to determine, for each non-zero value among the plurality of non-zero values, the corresponding load path and the address value of the associated MAC unit based on the mask value. In at least some embodiments, the unpacker is further configured to substitute each non-zero value among the plurality of non-zero values with an index value related to the non-zero value by an index. In at least some embodiments, the unpacker is further configured to associate the non-zero value with an associated MAC unit among the plurality of MAC units by determining a row identifier and a column identifier encoded in the non-zero value package, couple the non-zero value with the address value based on the column identifier, and determine the corresponding load path based on the row identifier.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. An integrated circuit comprising:
a plurality of multiply-and-accumulate (MAC) units;
a memory in communication with the plurality of MAC units;
an unpacker configured to receive packed non-zero values from the memory, and, for each non-zero value among the packed non-zero values,
correlate the non-zero value with a corresponding MAC unit among the plurality of MAC units,
combine the non-zero value with an address of the corresponding MAC unit, and
transmit the non-zero value and the address to a corresponding load path connected to the corresponding MAC unit among a plurality of load paths; and
wherein each MAC unit among the plurality of MAC units includes
a register configured to store the non-zero value received from the corresponding load path, and
an address decoder configured to instruct the register to store the non-zero value in response to validating the address received from the corresponding load path.

2. The integrated circuit of claim 1, wherein each MAC unit among the plurality of MAC units further includes
a multiplier configured to multiply the non-zero value from the register and an activation value from a run path to produce a product value, and
an adder configured to add the product value from the multiplier and an input sum value to produce an output sum value.

3. The integrated circuit of claim 1, further comprising a controller configured to
transmit, from the memory, the packed non-zero values to the unpacker,
transmit, from the memory, a plurality of activation values to the plurality of MAC units, and store, on the memory, a plurality of output sum values from the plurality of MAC units.

4. The integrated circuit of claim 1, wherein the controller is further configured to instruct each MAC unit among the plurality of MAC units to clear the register.

5. The integrated circuit of claim 1, wherein
the register includes a load register and an active register,
the controller is further configured to instruct each MAC unit among the plurality of MAC units to transfer the non-zero value from the load register to the active register.

6. The integrated circuit of claim 1, wherein
the packed non-zero values include an identifier of the corresponding MAC unit associated with each non-zero value among the packed non-zero values, and
the correlating the non-zero value with the corresponding MAC unit includes determining the corresponding load path and the address based on the identifier.

7. The integrated circuit of claim 1, wherein
the packed non-zero values include a mask value associated with each group of non-zero values among the packed non-zero values, and
the correlating the non-zero value with the corresponding MAC unit includes determining the corresponding load path and the address based on the mask value.

8. The integrated circuit of claim 1, wherein
the packed non-zero values include index values,
the unpacker is further configured to correlate each index value with the non-zero value by referring to an index.

9. The integrated circuit of claim 1, wherein
each MAC unit is identified by a row identifier and a column identifier,
the unpacker is further configured to determine the corresponding load path based on the row identifier, and
the address is the column identifier.

10. A system comprising
the integrated circuit of claim 1; and
a host computer in communication with the integrated circuit, the host computer configured to
determine a packing method of the packed non-zero values,
pack the non-zero values to produce the packed non-zero values according to the packing method, and
transmit the packed non-zero values to the memory.

11. The system of claim 10, wherein the packing method is one of addressing and masking.

12. An integrated circuit comprising:
a plurality of multiply-and-accumulate (MAC) units, each MAC unit among the plurality of MAC units includes
a register configured to store a non-zero value received from a corresponding load path among a plurality of load paths, and
an address decoder configured to store the non-zero value in the register in response to validating an address value coupled to the non-zero value;
a memory in communication with the plurality of MAC units, the memory storing a non-zero value package; and
an unpacker connected to the plurality of MAC units by the plurality of load paths, the unpacker configured to read the non-zero value package from the memory, and, for each non-zero value among a plurality of non-zero values in the non-zero value package,
associate the non-zero value with an associated MAC unit among the plurality of MAC units,
couple the non-zero value with the address value of the associated MAC unit, and
transmit the non-zero value and the address value through the corresponding load path connected to the associated MAC unit.

13. The integrated circuit of claim 12, wherein each MAC unit among the plurality of MAC units further includes
a multiplier configured to multiply the non-zero value from the register and an activation value from a run path to produce a product value, and
an adder configured to add the product value from the multiplier and an input sum value to produce an output sum value.

14. The integrated circuit of claim 12, further comprising a controller configured to
transmit, from the memory, the non-zero value package to the unpacker,
transmit, from the memory, a plurality of activation values to the plurality of MAC units, and store, on the memory, a plurality of output sum values from the plurality of MAC units.

15. The integrated circuit of claim 12, wherein the controller is further configured to instruct each MAC unit among the plurality of MAC units to clear the register.

16. The integrated circuit of claim 12, wherein
the register includes a load register and an active register, and
the controller is further configured to instruct each MAC unit among the plurality of MAC units to transfer the non-zero value from the load register to the active register.

17. The integrated circuit of claim 12, wherein
the non-zero value package includes, for each non-zero value among the plurality of non-zero values, an identifier of the corresponding MAC unit associated with the non-zero value, and
the unpacker is further configured to determine, for each non-zero value among the plurality of non-zero values, the corresponding load path and the address value of the associated MAC unit based on the identifier.

18. The integrated circuit of claim 12, wherein
the plurality of non-zero values are separated into groups of non-zero values, each group associated with a mask value, and
the unpacker is further configured to determine, for each non-zero value among the plurality of non-zero values, the corresponding load path and the address value of the associated MAC unit based on the mask value.

19. The integrated circuit of claim 12, wherein the unpacker is further configured to substitute each non-zero value among the plurality of non-zero values with an index value related to the non-zero value by an index.

20. The integrated circuit of claim 12, wherein the unpacker is further configured to
associate the non-zero value with an associated MAC unit among the plurality of MAC units by determining a row identifier and a column identifier encoded in the non-zero value package,
couple the non-zero value with the address value based on the column identifier, and
determine the corresponding load path based on the row identifier.
